(19) United States
(12) Patent Application Publication
(10) Pub. No.: US 2023/0042937 A1
(43) Pub. Date: Feb. 9, 2023

(54) AIRCRAFT WING

(71) Applicant: Changman LEE, Seoul (KR)

(72) Inventor: Changman LEE, Seoul (KR)

(21) Appl. No.: 17/875,413

(22) Filed: Jul. 28, 2022

(30) Foreign Application Priority Data
Aug. 6, 2021 (KR) 10-2021-0103695

(51) Int. Cl. B64C 3/54; B64C 3/18; B64C 3/26

(52) U.S. Cl. CPC B64C 3/54; B64C 3/187; B64C 3/26

(57) ABSTRACT

An aircraft wing includes: a supporting wing portion; and an auxiliary thrust generation wing portion provided behind the supporting wing portion based on a progress direction of an aircraft, and generating force in the direction of thrust by using a pressure change formed at a posterior side of the supporting wing portion while the thrust is applied.

### TECHNICAL FIELD

The present invention relates to an aircraft.

### BACKGROUND ART

In general, an aircraft is used for flight in the air and is a means of transportation of people or objects through the sky. Such aircraft includes a fuselage that accommodates people or objects, a propulsion device that provides thrust, and a wing that provides lifelong based on thrust.

In particular, among the aerodynamic forces acting on the wings of the aircraft, the lift is the force that lifts the aircraft into the air, which is caused by the pressure difference between the air flow between the upper curved surface and the lower curved surface. In other words, according to the theorem of Bernoulli, if the speed of the air flowing through the upper curved surface of the wing is faster than the speed of the air flowing the lower curved surface of the wing, the pressure of the lower part of the wing is relatively high and the lift is generated.

FIG, 1 is a diagram schematically illustrating an airfoil which is a cross section of the existing aircraft wing.

The existing aircraft wing, as illustrated in FIG. 1, supports a skin 10 which forms the appearance of the upper curved surface 11 and the lower curved surface 12, and a plurality of ribs 20 which supports the skin in upper and lower directions inside the skin 10.

However, the existing aircraft wing is that when the thrust is applied, the lift is generated due to the pressure difference between the upper curved surface 11 and the lower curved surface 12, but there is a limit that cannot be added in the direction of the thrust.

### DISCLOSURE

### Technical Problem

A technical object of the present invention is to provide an aircraft wing that can give additional force in the direction of thrust.

### Technical Solution

In order to achieve the object, an aircraft wing of the present invention includes: a supporting wing portion; and an auxiliary thrust generation wing portion provided behind the supporting wing portion based on a progress direction of an aircraft, and generating force in the direction of thrust by using a pressure change formed at a posterior side of the supporting wing portion while the thrust is applied.

The supporting wing portion may also be involved in a lift and not involved in the lift.

The aircraft wing according to the embodiment of the present invention may be provided spaced behind an existing wing involved in the lift. The existing wing and the supporting wing portion may be connected by a connection member.

The auxiliary thrust generation wing portion may include an auxiliary skin provided behind the supporting wing portion, and excited in upper and lower directions while the thrust of the aircraft is applied, and an elastic support portion provided inside the auxiliary skin, and elastically supporting the auxiliary skin so as to apply restoration force in the direction of the thrust while the auxiliary skin is excited in the upper and lower directions.

As an aspect, the elastic support portion may include a plurality of auxiliary ribs including first and second auxiliary ribs provided vertically inside the auxiliary skin to support between an upper surface portion and a lower surface portion of the auxiliary skin, and provided at an interval in an opposite direction to the progress direction of the aircraft, and an elastic portion elastically supporting between the first and second auxiliary ribs.

The elastic portion may further include a progress direction central axis which is provided lengthily in the progress direction of the aircraft to form a central axis of the elastic portion, and connects the plurality of auxiliary ribs and has elasticity enough to be bent, and a longitudinal direction support axis which is provided at a front end portion of the progress direction central, and provided lengthily in the longitudinal direction of the aircraft wing, and provided on a first auxiliary rib.

As an example, the elastic portion may include an upper elastic body provided between the first and second auxiliary ribs, and located close to the upper surface portion of the auxiliary skin, and a lower elastic body provided between the first and second auxiliary ribs, and located close to the lower surface portion of the auxiliary skin.

The upper elastic body and the lower elastic body may be vertically symmetric to each other based on the progress direction central axis.

One end and the other end of the upper elastic body may be fixed to the first and second auxiliary ribs, respectively, and one end and the other end of the lower elastic body may be fixed to the first and second auxiliary ribs, respectively.

As an example, the upper elastic body may be a leaf spring having a convex shape toward the lower surface portion of the auxiliary skin, and the lower elastic body may be a leaf spring having a convex shape toward the upper surface portion of the auxiliary skin.

As another example, each of the upper elastic body and the lower elastic body may be a coil spring.

As another example, the elastic portion may be an elastic body provided between the first and second auxiliary ribs, and located in a middle portion between the upper surface portion and the lower surface portion of the auxiliary skin. Here, the elastic body may be the coil spring.

As yet another example, the elastic portion may include an upper leaf spring provided in the upper surface portion of the auxiliary skin and having a wrinkled shape in which a mountain and a valley are repeated in the progress direction of the aircraft, and a lower leaf spring provided in the lower surface portion of the auxiliary skin and may have the wrinkled shape in which the mountain and the valley are repeated in the progress direction of the aircraft.

A mount portion adjacent to the upper surface portion of the auxiliary skin in the upper leaf spring may be fixed to the upper surface portion of the auxiliary skin and a valley portion adjacent to the lower surface portion of the auxiliary skin in the lower leaf spring may be fixed to the lower surface portion of the auxiliary skin.

As another aspect, the elastic support portion may include a ceiling support rib supporting a ceiling surface of the upper surface portion of the auxiliary skin, a bottom support rib supporting a bottom surface of the lower surface portion of the auxiliary skin, and an elastic portion elastically supporting between the ceiling support rib and the bottom support rib.

A rear end of the ceiling support rib and the rear end of the bottom support rib may be firmly fixed to each other.

The elastic portion may connect the ceiling support rib and the bottom support rib, and include first and second leaf springs connected in a crossed form at the center thereof.

As an example, the auxiliary skin may have a cross section having a wrinkled shape in the progress direction of the aircraft.

As an example, the auxiliary skin may be made of a material which is stretchable in a range of an excited degree. For example, the auxiliary skin may be made of a titanium material.

### Advantageous Effects

As described above, the aircraft wing according to the embodiment of the present invention can have the following effects.

According to the embodiment of the present invention, since a technical including a supporting wing portion and an auxiliary thrust generation wing portion is provided, additional force can be generated in the direction of thrust through the auxiliary thrust generation wing portion using a pressure change formed on a background side of the supporting wing portion while the thrust is applied by a propulsion device of an aircraft, thereby reducing the fuel economy of the propulsion device of the aircraft or if an output of the same propulsion device is used, a speed of the aircraft can be increased by the additional force.

### DESCRIPTION OF DRAWINGS

FIG. 1 is a diagram schematically illustrating an airfoil which is a cross section of the existing aircraft wing.

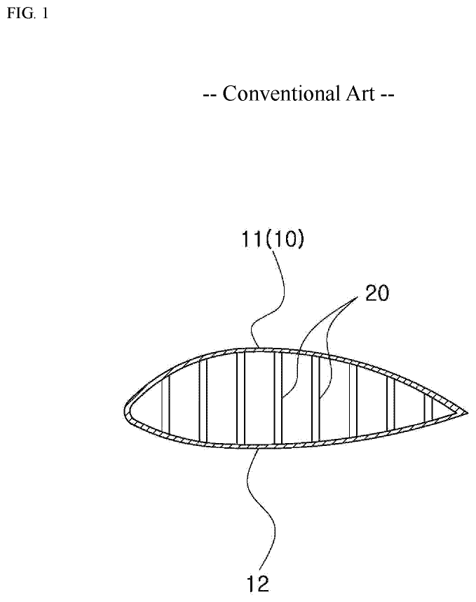

FIG. 2 is a diagram schematically illustrating an airfoil of an aircraft wing according to a first embodiment of the present invention.

FIG. 3 is a diagram illustrating one example for describing additional force in the direction of thrust generated from the aircraft wing of FIG. 2.

FIG. 4 is a diagram illustrating another example for generating the additional force in the direction of thrust generated from the aircraft wing of FIG. 2.

FIG. 5 is a diagram schematically illustrating an airfoil of an aircraft wing according to a second embodiment of the present invention.

FIG. 6 is a diagram schematically illustrating an airfoil of an aircraft wing according to a third embodiment of the present invention.

FIG. 7 is a diagram schematically illustrating an airfoil of an aircraft wing according to a fourth embodiment of the present invention.

FIG. 8 is a diagram schematically illustrating an airfoil of an aircraft wing according to a fifth embodiment of the present invention.

FIG. 9 is a diagram schematically illustrating an airfoil of an aircraft wing according to a sixth embodiment of the present invention.

### MODES FOR THE INVENTION

Hereinafter, an embodiment of the present invention will be described more fully hereinafter with reference to the accompanying drawings so as to be easily implemented by those skilled in the art. However, the present invention may be modified in various different ways, all without departing from the spirit or scope of the present invention.

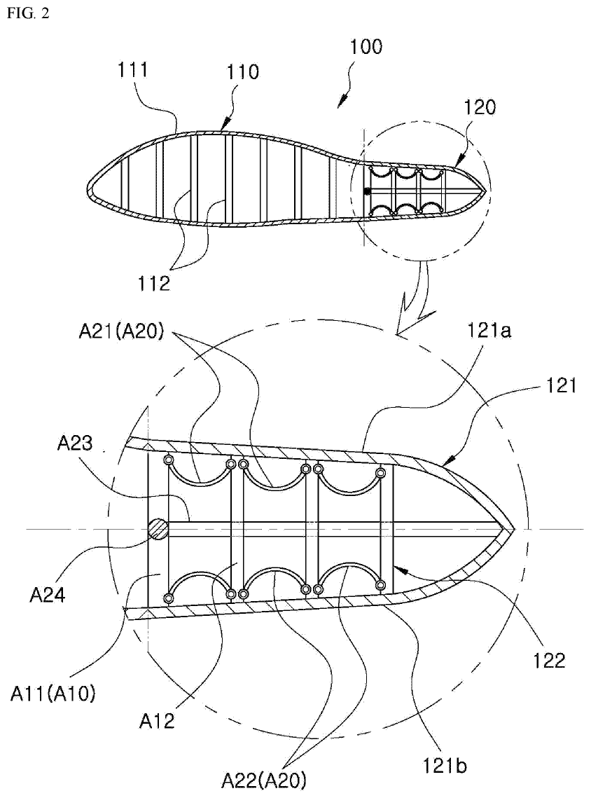

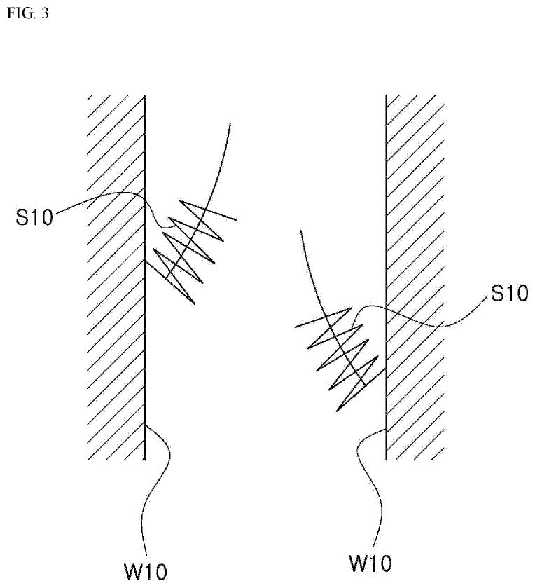

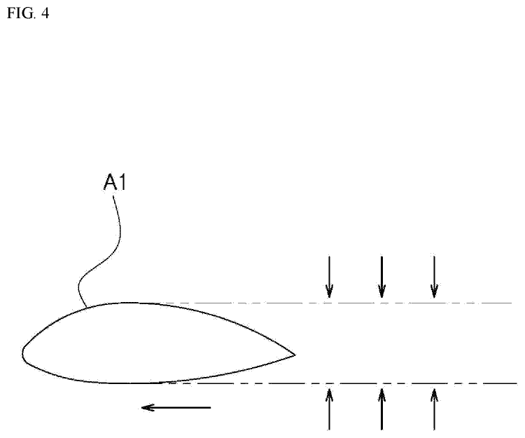

FIG. 2 is a diagram schematically illustrating an airfoil of an aircraft wing according to a first embodiment of the present invention. FIG. 3 is a diagram illustrating one example for describing additional force in the direction of thrust generated from the aircraft wing of FIG. 2 and FIG. 4 is a diagram illustrating another example for generating the additional force in the direction of thrust generated from the aircraft wing of FIG. 2.

The aircraft wing 100 according to the first embodiment of the present invention includes a supporting wing portion 110 and an auxiliary thrust generation wing portion 120 as illustrated in FIGS. 2 to 4. Hereinafter, each component will be described in more detail by continuously referring to FIGS. 2 to 4.

The supporting wing portion 110 is a component that forms an approximately first half of the aircraft wing of the present invention in order to support the auxiliary thrust generation wing portion 120. The supporting wing portion 110 may include a main skin 111 and a plurality of main ribs 112 as illustrated in FIG. 2. The plurality of main ribs 112 may support an upper curved surface and a lower curved surface in upper and lower directions.

The supporting wing portion 110 may be involved in a lift or may not be involved in the lift. For example, when the supporting wing portion 110 is involved in the lift, the supporting wing portion 110 may have the existing wing structure to generate the lift based on the thrust of a thrusting device such as an engine. Therefore, when the thrust is applied, pressure of the upper curved surface of the main skin 111 may be lower than the pressure of the lower curved surface, which may generate the lift.

The auxiliary thrust generation wing portion 120 is a component that generates force in the direction of the thrust by using a pressure change formed on a posterior side of the supporting wing portion 110 while the thrust is applied. The auxiliary thrust generation wing portion 120 may be provided behind the supporting wing portion 110 based on a progress direction of the aircraft, as illustrated in FIG. 2.

Therefore, since the components are provided, additional force may be generated in the direction of the thrust through the auxiliary thrust generation wing portion 120 using the pressure change formed on the posterior side of the supporting wing portion 110 while the thrust is applied by a propulsion device (not illustrated) of the aircraft, thereby reducing the fuel economy of the propulsion device of the aircraft or if an output of the same propulsion device is used, a speed of the aircraft can be increased by the additional force.

Hereinafter, a principle of generating the additional force (auxiliary thrust) will be described with reference to FIGS. 3 and 4.

It is assumed that a rope (not illustrated) comes down from the above and is connected to a human body, and the rope is pulled from the above and a person goes up. In this case, in addition to force of pulling the rope, as illustrated in FIG. 3, when the person goes up between both walls W10 enough to stretch hands of the person, i.e., when the person goes up jointly while pushing both walls W10 with a foot, the person may go up faster than going up by just pulling only the rope.

In particular, as illustrated in FIG. 3, when it is thought that person goes up by stepping horizontally with not both legs but one leg, a bone of the leg is considered as one central axis which is bendable and the muscle may be replaced with a spring and applied. Such a similar example may be seen in an example in which the leg is replaced with the spring similarly to a leg made of the spring in the athletic game for the disabled. However, the athletics is headed in one direction, but there is a central axis because the athletics is similar to a round-trip movement.

When such a phenomenon is rotated at 90 degrees in a counterclockwise direction as illustrated in FIG. 4, the person is drawn up by the force of pulling the rope may be immediately compared with the aircraft going forward in a progress direction by the thrust. Here, when the force of the spring is given to a general aircraft wing A1, the spring elastically receives force while being repeatedly pressed in the upper and lower directions by external pressure (see a vertical arrow in FIG. 4) generated from the posterior side of the wing A1 and restoration force of the spring is continuously generated, and the continuously generated restoration force of the spring may be added to the progress direction (see a horizontal arrow of FIG. 4).

In addition, as the aircraft flies, the air passes up and down the aircraft and the wing also goes to the progress direction, and as a result, the pressure is lowered while the air is rate at a passed portion of a wing part direction of progress and the air is rushed to upper and lower portions where the air is rate again. In this case, as the air flows from a portion where there is a lot of air, i.e., a portion having high pressure to a portion there is less air, i.e., a portion having low pressure, the progress direction (see the vertical arrow of FIG. 4) of the pressure is headed while facing symmetrically centering on a space through which a rear surface of the wing passes (see FIG. 4), and when the spring is pressed by the pressure applied in the upper and lower directions, the pressure may be added to the restoration force in the direction (see the horizontal arrow of FIG. 4) of the thrust. In particular, a movement direction of a sum of contraction or relaxation of the spring, i.e., a direction of a vector is in line with or parallel with the progress direction of the aircraft.

Although not illustrated, as a similar case thereto, when the air passes between flags placed parallel to the ground, at the moment when the flag is pushed from the bottom by such a pressure difference and moves up, the flag is repeatedly pushed from the top and moves down. That is, since the flag is almost thin, the end of the flag is almost fluttered in place.

A current aircraft wing is hard and does not move like the flag, but if the wing has a slight curve mobility, the aircraft wing goes up by the pressure of the air which comes from the bottom and is pushed, and goes down by the pressure of the air which comes down from the top repeatedly similarly to the case of the flag. However, the flag is thin, so the flag trembles almost in place, but the aircraft wing is thicker than the flag, so a slight more space is present and the wing will have up and down mobility at any degree by the pressure of the air which is rushed from the top to the bottom.

Therefore, when by adding the auxiliary thrust generation wing portion 120 such as the spring to the aircraft wing 100 of the present invention, the auxiliary thrust generation wing portion 120 such as the spring is made to move by receiving the pressure (the pressure pushed in a vertical direction to the wing) generated by the air passing through the upper and lower portions of the wing, the auxiliary thrust generation wing portion is influenced by force (restoration force) of being bounced in a stronger form as if the auxiliary thrust generation wing portion is bounded in contact with a contact surface (a virtual surface supporting an elastic support portion by the pressure) to give an additional weight effect on the force of the aircraft progress direction.

Hereinafter, referring back to FIG. 2, the auxiliary thrust generation wing portion 120 will be described in more detail.

The auxiliary thrust generation wing portion 120 may include an auxiliary skin 121 and an elastic support portion 122 as illustrated in FIG. 2.

The auxiliary skin 121 may be provided behind the main skin 111, and excited in the upper and lower directions while the thrust of the aircraft is applied. The elastic support portion 122 may be provided inside the auxiliary skin 121, and may elastically support the auxiliary skin 121 so as to apply the restoration force in the direction of the thrust while the auxiliary skin 121 is excited in the upper and lower directions. Therefore, the auxiliary skin 121 may be excited in the upper and lower directions as if the flag trembles by the pressure change formed on the posterior side of the supporting wing portion 110 while the thrust is applied by the propulsion device (not illustrated) of the aircraft, and the elastic support portion 122 may provide additional force to the thrust of the aircraft by applying the restoration force in the direction of the thrust while the auxiliary skin 121 is excited.

Further, although not illustrated, the auxiliary thrust generation wing portion 120 may also be provided throughout an entire section behind the supporting portion 110, but may not also be provided throughout the entire section behind the supporting wing portion 110, but provide in one or more sites at an interval in a longitudinal direction of the supporting wing portion 110.

Further, as illustrated in FIG. 2, the elastic support portion 122 may include a plurality of auxiliary ribs A10 and elastic portions A20. The plurality of auxiliary ribs A10 may be provided vertically inside the auxiliary skin 121 to support between an upper surface portion 121a and a lower surface portion 121b of the auxiliary skin 121, and may include first and second auxiliary ribs A11 and A12 sequentially provided at an interval in an opposite direction to the progress direction of the aircraft. The elastic portion A20 may elastically support between the first and second auxiliary ribs A11 and A12.

For example, as illustrated in FIG. 2, the elastic portion A20 may include a progress direction central axis A23 and a longitudinal direction support axis A24. The progress direction central axis A23 may be provided lengthily in the progress direction of the aircraft to form a central axis of the elastic portion A20, and may connect the plurality of auxiliary ribs A10 and have elasticity enough to be bent. The longitudinal direction support axis A24 may be provided at a front end portion of the progress direction central axis A23, and provided lengthily in the longitudinal direction of the aircraft wing 100, and mounted on a first auxiliary rib A11. Furthermore, the longitudinal direction support axis A24 may be placed at the center of the aircraft wing of the present invention, or located behind the center or before the center based on the progress direction of the aircraft. Therefore, while the auxiliary skin 121 is excited in the upper and lower directions, the restoration force may be provided by self elasticity of the progress direction central axis A23 while the progress direction central axis A23 is bent in the upper and lower directions based on the longitudinal direction support axis A24.

Furthermore, as illustrated in FIG. 2, the elastic portion A20 may further include an upper elastic body A21 and a lower elastic body A22. The upper elastic body A21 may be provided between the first and second auxiliary ribs A11 and A12, and located close to the upper surface portion 121a of the auxiliary skin 121. The lower elastic body A22 may be provided between the first and second auxiliary ribs A11 and A12, and provided close to the lower surface portion 121b of the auxiliary skin 121. Therefore, when the upper elastic body A21 is relaxed while the auxiliary skin 121 is excited in the upper and lower directions, the lower elastic body A22 is contracted and when the lower elastic body A22 is relaxed, the additional force (restoration force) may be applied in the direction of the thrust while a phenomenon in which the upper elastic body A21 is contracted is repeated.

Further, the upper elastic body A21 and the lower elastic body A22 may be vertically symmetric to each other based on the progress direction central axis A23 as illustrated in FIG. 2. Therefore, a vector sum of the restoration force of the upper elastic body A21 and the restoration force of the lower elastic body A22 may more accurately act in the progress direction of the aircraft.

Further, as illustrated in FIG. 2, one end and the other end of the upper elastic body A21 may be fixed to the first and second auxiliary ribs A11 and A12, respectively, and one end and the other end of the lower elastic body A22 may be fixed to the first and second auxiliary ribs A11 and A12, respectively.

For example, as illustrated in FIG. 2, the upper elastic body A21 may be a leaf spring having a convex shape toward the lower surface portion 121b of the auxiliary skin 121, and the lower elastic body A22 may be a leaf spring having a convex shape toward the upper surface portion 121a of the auxiliary skin 121. Therefore, when the leaf spring is used, stronger force may be applied than a coil spring, the leaf spring may be adopted in an aircraft model that requires a strong thrust.

Hereinafter, referring back to FIG. 2, the auxiliary skin 121 will be described in detail.

As an example, the auxiliary skin 121 may be made of a material which is stretchable in a range of an excited degree. For example, the auxiliary skin 121 may be made of a material such as titanium, etc. For reference, although not illustrated, a motion restriction means may be added between the auxiliary rib and the auxiliary rib in order to restrict the range of the excited degree.

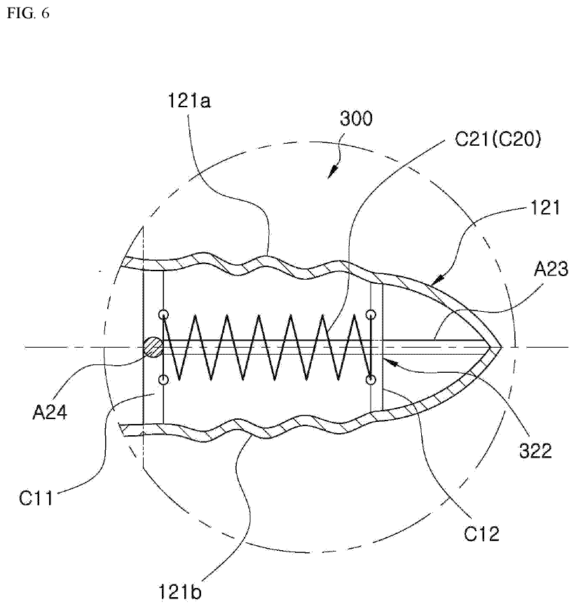

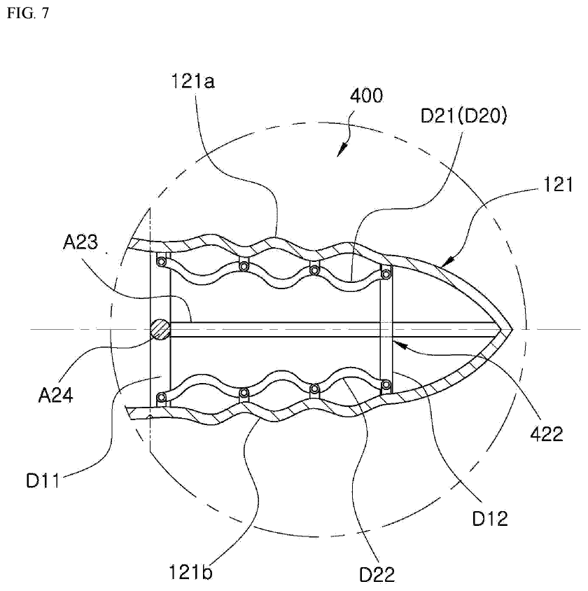

As another example, the auxiliary skin 121 may have a cross section having a wrinkled shape in the progress direction of the aircraft (see FIG. 6 or 7). Therefore, the auxiliary skin 121 may be excited while a phenomenon in which the auxiliary skin 121 is unwrinkled or wrinkled again is repeated.

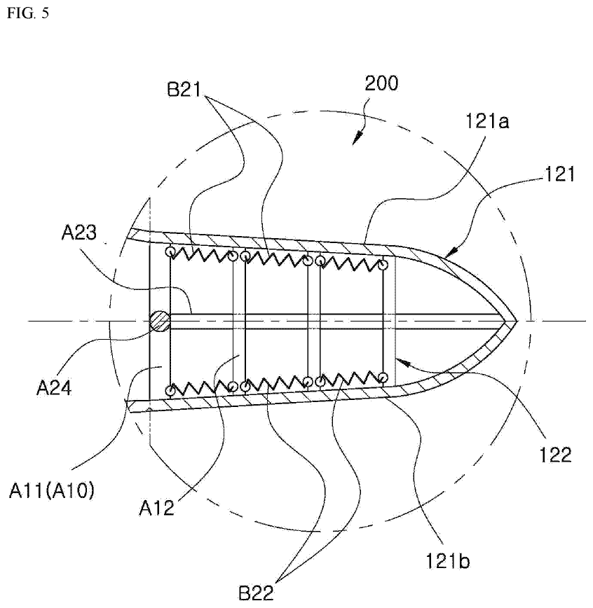

Hereinafter, an aircraft wing 200 according to a second embodiment of the present invention will be described with reference to FIG. 5.

FIG. 5 is a diagram schematically illustrating an airfoil of an aircraft wing according to a second embodiment of the present invention.

The aircraft wing 200 according to the second embodiment of the present invention is the same as the first embodiment of the present invention described above except for an upper elastic body B21 and a lower elastic body B22 as illustrated in FIG. 5, and as a result, hereinafter, this will be primarily described.

The upper elastic body B21 and the lower elastic body B22 may be the coil springs as illustrated in FIG. 5. When the coil spring is used, the force is not stronger than the leaf spring (see reference numeral A20 of FIG. 2) of the first embodiment, but may respond to fast motility, so the coil spring may be adopted in an aircraft model that requires a fast motility.

Hereinafter, an aircraft wing 300 according to a third embodiment of the present invention will be described with reference to FIG. 6.

FIG. 6 is a diagram schematically illustrating an airfoil of an aircraft wing according to a third embodiment of the present invention.

The aircraft wing 300 according to the third embodiment of the present invention is the same as the first embodiment of the present invention described above except for an elastic support portion 322 as illustrated in FIG. 6, and as a result, hereinafter, this will be primarily described.

As illustrated in FIG. 6, the elastic support portion 322 may include first and second auxiliary ribs C11 and C12, and an elastic portion C20. Further, the elastic portion C20 may be provided between the first and second auxiliary ribs C11 and C12, and may be an elastic body C21 provided at a middle portion between the upper surface portion 121a and the second lower surface portion 121b of the auxiliary skin 121. Here, the elastic body C21 may be the coil spring. Furthermore, the elastic portion C20 may further include the progress direction central axis A23 and the longitudinal direction support axis A24 similarly to the first embodiment of the present invention described above.

Therefore, since one elastic body C21 is used, which is installed in the middle between two auxiliary ribs C11 and C12 as the elastic portion C20, the elastic body C21 may be comparatively simply installed in the wing of a light aircraft or a glider.

Hereinafter, an aircraft wing 400 according to a fourth embodiment of the present invention will be described with reference to FIG. 7.

FIG. 7 is a diagram schematically illustrating an airfoil of an aircraft wing according to a fourth embodiment of the present invention.

The aircraft wing 400 according to the fourth embodiment of the present invention is the same as the first embodiment of the present invention described above except for an elastic support portion 422 as illustrated in FIG. 7, and as a result, hereinafter, this will be primarily described.

As illustrated in FIG. 7, the elastic support portion 422 may include first and second auxiliary ribs D11 and D12, and an elastic portion D20. Further, as illustrated in FIG. 7, the elastic portion D20 may include an upper leaf spring D21 and a lower leaf spring D22. For reference, in that the upper leaf spring D21 and the lower leaf spring D22 are not provided in the auxiliary ribs D11 and D12, and provided in the auxiliary skin 121, the fourth embodiment of the present invention is different from the first embodiment of the present invention. Furthermore, the elastic portion D20 may further include the progress direction central axis A23 and the longitudinal direction support axis A24 similarly to the first embodiment of the present invention described above.

As illustrated in FIG. 7, the upper leaf spring D21 may be provided in the upper surface portion 121a of the auxiliary skin 121 and may have a wrinkled shape in which a mountain and a valley are repeated in the progress direction of the aircraft. In particular, a mount portion adjacent to the upper surface portion 121a of the auxiliary skin 121 in the upper leaf spring D21 may be fixed to the upper surface portion of the auxiliary skin 121.

As illustrated in FIG. 7, the lower leaf spring D22 may be provided in the lower surface portion 121b of the auxiliary skin 121 and may have the wrinkled shape in which the mountain and the valley are repeated in the progress direction of the aircraft. In particular, a valley portion adjacent to the lower surface portion 121b of the auxiliary skin 121 in the lower leaf spring D22 may be fixed to the lower surface portion 121b of the auxiliary skin 121.

Therefore, since the upper leaf spring D21 and the lower leaf spring D22 need not be provided in the auxiliary ribs D11 and D12, an installation degree of freedom may be increased.

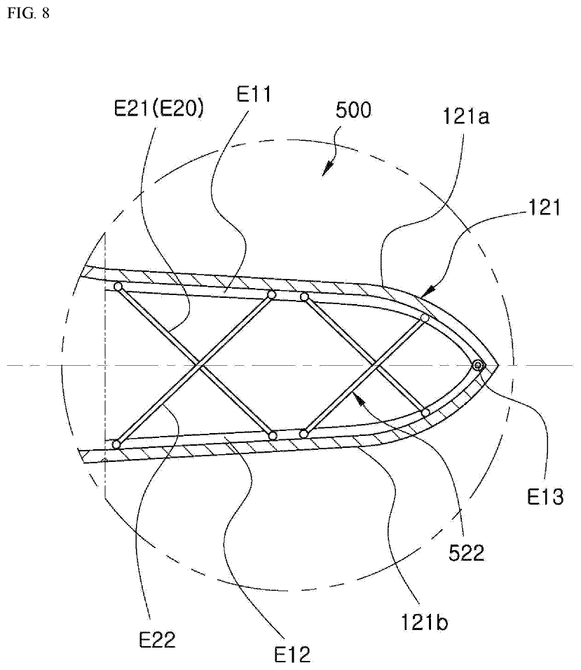

Hereinafter, an aircraft wing 500 according to a fifth embodiment of the present invention will be described with reference to FIG. 8.

FIG. 8 is a diagram schematically illustrating an airfoil of an aircraft wing according to a fifth embodiment of the present invention.

The aircraft wing 500 according to the fifth embodiment of the present invention is the same as the first embodiment of the present invention described above except for an elastic support portion 522 as illustrated in FIG. 8, and as a result, hereinafter, this will be primarily described.

As illustrated in FIG. 8, the elastic support portion 522 may include a ceiling support rib E11, a bottom support rib E12, and an elastic portion E20. The ceiling support rib E11 may support a ceiling surface of the upper surface portion of the auxiliary skin, and the bottom support rib E12 may support a bottom surface of the lower surface portion of the auxiliary skin. The elastic portion E20 may elastically support between the ceiling support rib E11 and the bottom support rib E12. A rear end of the ceiling support rib E11 and the rear end of the bottom support rib E12 may be firmly fixed to each other in order to increase the restoration force (see E13).

Furthermore, as illustrated in FIG. 8, the elastic portion E20 may connect the ceiling support rib E11 and the bottom support rib E12, and include first and second leaf springs E21 and E22 connected in a crossed form at the center thereof. However, the ceiling support rib E11 and the bottom support rib E12 are made of an elastic material similarly to the progress direction central axis (see reference numeral A23 of FIG. 2) to provide the restoration force depending on bending.

Accordingly, unlike the embodiments, a structure may be simplified in that the progress direction central axis is not required.

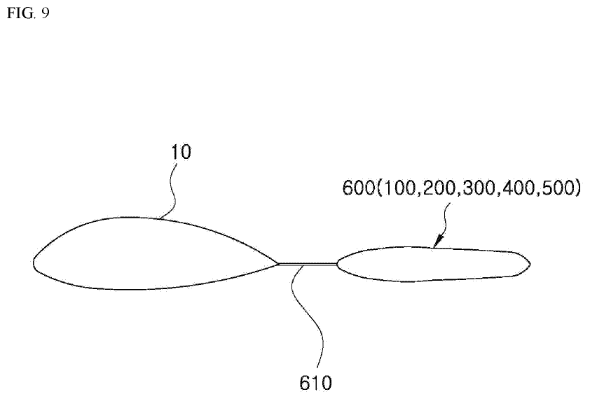

Hereinafter, an aircraft wing 600 according to a sixth embodiment of the present invention will be described with reference to FIG. 9.

FIG. 9 is a diagram schematically illustrating an airfoil of an aircraft wing according to a sixth embodiment of the present invention.

The aircraft wing 600 according to the sixth embodiment of the present invention is the same as the embodiments described above except the aircraft wing 600 is provided spaced behind the existing wing 10 involved in the lift as illustrated in FIG. 9.

As illustrated in FIG. 9, the aircraft wing 600 of the present invention and the existing wing 10 may be connected by a connection member 610. For reference, in addition to a case where the support wing portion of the aircraft wing 600 is not involved in life generation, even a case where the support wing portion is involved in the lift generation, the support wing portion may be provided spaced behind the existing wing 10.

While this invention has been described in connection with what is presently considered to be practical example embodiments, it is to be understood that the invention is not limited to the disclosed embodiments, but, on the contrary, is intended to cover various modifications and equivalent arrangements included within the spirit and scope of the appended claims.

### EXPLANATION OF REFERENCE NUMERALS AND SYMBOLS

100, 200, 300, 400, 500, 600: Aircraft wing

110: Supporting wing portion

111: Main skin

112: Main rib

120: Auxiliary thrust generation wing portion

121: Auxiliary skin

122, 322, 422, 522: Elastic support portion

A11, C11, D11, E11: First auxiliary rib

A12, C12, D12, E12: Second auxiliary rib

A20, C20, D20, E20: Elastic portion

A21, B21: Upper elastic body

A22, B22: Lower elastic body

A23: Progress direction central axis

A24: Longitudinal direction support axis

C21: Elastic body

D21: Upper leaf spring

D22: Lower leaf spring

E21: First leaf spring

E22: Second leaf spring

1. An aircraft wing comprising:
a supporting wing portion; and
an auxiliary thrust generation wing portion provided behind the supporting wing portion based on a progress direction of an aircraft, and generating force in the direction of thrust by using a pressure change formed at a posterior side of the supporting wing portion while the thrust is applied.

2. The aircraft wing of claim 1, wherein the auxiliary thrust generation wing portion includes
an auxiliary skin provided behind the supporting wing portion, and excited in upper and lower directions while the thrust of the aircraft is applied, and
an elastic support portion provided inside the auxiliary skin, and elastically supporting the auxiliary skin so as to apply restoration force in the direction of the thrust while the auxiliary skin is excited in the upper and lower directions.

3. The aircraft wing of claim 2, wherein the elastic support portion includes
first and second auxiliary ribs supporting an upper surface portion and a lower surface portion of the auxiliary skin; and
an elastic portion elastically supporting between the first and second auxiliary ribs.
